(19) United States
(12) Patent Application Publication
(10) Pub. No.: US 2006/0225364 A1
(43) Pub. Date: Oct. 12, 2006

(54) Door sealing system for inclement weather

(76) Inventor: Kuei Yung Wang Chen, Taipei (TW)

Correspondence Address: Joseph L. Strabala, Esq.;Law Office of Joseph L. Strabala, Suite 1020, One Embarcadero Center, San Francisco, CA, 94111, US

(21) Appl. No.: 11/078,177

(22) Filed: Mar. 14, 2005

(51) Int. Cl. E06B 1/70

(52) U.S. Cl. 49/467

(57) ABSTRACT

A door system for resisting severe inclement weather conditions designed to open into a building, includes a rectangular door frame having an aperture with a door hingedly mounted on said frame to swing to open such aperture in said frame and swing to close such aperture in said frame and a sill member at the bottom of said frame completing the frame, the sill member including an elongated rib extending vertically from said sill along its entire length with the height of said rib being sufficient to overlap a vertical face associated with the bottom of the door and a seal between a vertical face of the rib and the vertical surface associated with the bottom of the door whereby wind and wind driven rain-passage beneath the door will be restricted when said door is closed against the seal. A further improvement includes the inclusion of a channel running lengthwise of the sill member to drain rain water away from the bottom of the door mounted in the fame. A still further improvement is the use of a plate connected to the bottom of the door to provide the vertical surface that abuts against the seal on the vertical rib of the sill member to seal out inclement weather.

### BACKGROUND

Doors in conventional residential and commercial structures provide a means of ingress and egress. As such they must swing open and close for this purpose. However, leaving gaps between the fame and sill of the door for smooth swinging operation is not satisfactory for many reasons. Such gaps allow air to pass through the gaps and in the case of heated structures to loose energy through such gaps. Likewise in a structure which is air conditioned, energy will also be lost though such gaps.

The most difficult gap to control is the one under the door, between the sill and the bottom of the door, as the other gaps can be controlled by molding mounted on the door frame so that a surface of the molding abuts against the outer face of the door when it is closed; in addition weather stripping can be applied between this molding surface(s) and the face of the door without adversely effecting the operation of the door.

Between the bottom of the door and the door sill special seals are employed in an attempt to control this gap. One such seal is a flat, elongated, elastomer flange that is mounted on the outer face of the door so that it projects below the bottom of the door enabling the bottom edge of flange to engage the sill to form a seal when the door is closed. Another seal is a raised elastomers bubble placed on the sill which is depressed (deformed) by the bottom of the door when door closes so that the bubble's surface positively engages the bottom of the door along the entire bottom edge.

The afore described seals are somewhat effective but are often unsatisfactory against high winds, and high winds accompanied by rain. In such cases the wind and wind driven rain will often penetrate such seals between the bottom of the door and its associated door sill. Further, such seals loose their elasticity in time and ultimately fail to seal out wind and water ingress under the door. Moreover pedestrian and other traffic across these devices can damage such device

This invention is designed to provide an improved seal between a bottom of a door and its door sill which is effective against high winds and high winds with rain (wind driven rain). For example during severe weather conditions, wind speeds of 60 mph are not extraordinary and during hurricanes the winds and wind driven rain impacting against a door can have much higher velocities.

An object is to provide a combination of an economical door sill and a cooperating plate for attachment to the bottom of a door which together provide an improved seal resistant to the ingress of high winds and wind driven rain.

Still another object is to provide a novel door sill that has a drain channel before a final seal which will transport rain water collecting under the door away from the bottom of the door.

Other objects will be apparent from the specification and the accompanying drawings.

### SUMMARY OF THE INVENTION

A door system for resisting severe inclement weather conditions includes a rectangular door frame having an aperture with a door hingedly mounted on said frame to swing to open such aperture in said frame and swing to close such aperture in said frame and a sill member at the bottom of said frame completing the frame, the sill member including an elongated rib extending vertically from said sill along its entire length, the height of said rib being sufficient to overlap a vertical face associated with the bottom of the door and a seal between a vertical face of the rib and the vertical surface associated with the bottom of the door whereby wind and wind driven rain passage beneath the door will be restricted when said door is closed against the seal. A further improvement includes the inclusion of a channel running lengthwise of the sill member to port rain water away for the bottom of the door mounted in the fame. A still further improvement is the use of a plate connected to the bottom of the door which provides the vertical surface which holds a seal that abuts on the vertical rib of the sill member to seal out inclement weather.

### DESCRIPTION OF THE DRAWINGS

FIG. 1 is a perspective of the sill member of this invention illustrating the raised rib;

FIG. 2 is an exploded perspective of a portion of the sill member shown FIG. 1. with the extruded aluminum frame partially assembled on the extruded foamed core member of the sill member;

FIG. 3 is a reverse perspective of the sill parts illustrated in FIG. 2 with the aluminum frame partially assembled on the extruded core member;

FIG. 4 is a vertical cross section of the door and the sill member, with parts broken away, illustrating the sealing contact between the raised rib and the vertical surface of the associated door and the door frame illustrated in phantom with dotted lines; and

FIG. 5 is a broken away perspective of an alternate embodiment of the invention which utilizes a drain door to discharge water from the interior drain channel in the door system.

### DESCRIPTION OF THE PREFERRED EMBODIMENT

With the development of foamed plastic materials, which allow components to be extruded with desired profiles, these extrusions provide components which do not require further milling or further shaping to achieve a desired profile. As a result, such extruded components formed using the process in applicant's U.S. Letters Pat. No. 6,551,537 issued to Chen, offer the advantage of replacing wood components in door and window frame construction at a cost saving, plus the added advantage of replacement components which are resistant to rot and mildew.

While significant cost advantages can be achieved with foamed plastic profiles, such profiles do not always have the necessary physical attributes for all applications in window and door frame construction. However because the extrusion process allows greater control of the dimensions in the final cross section, profiles can be manufactured which interlock with extruded metal components to create a final component which has all the necessary physical attributes.

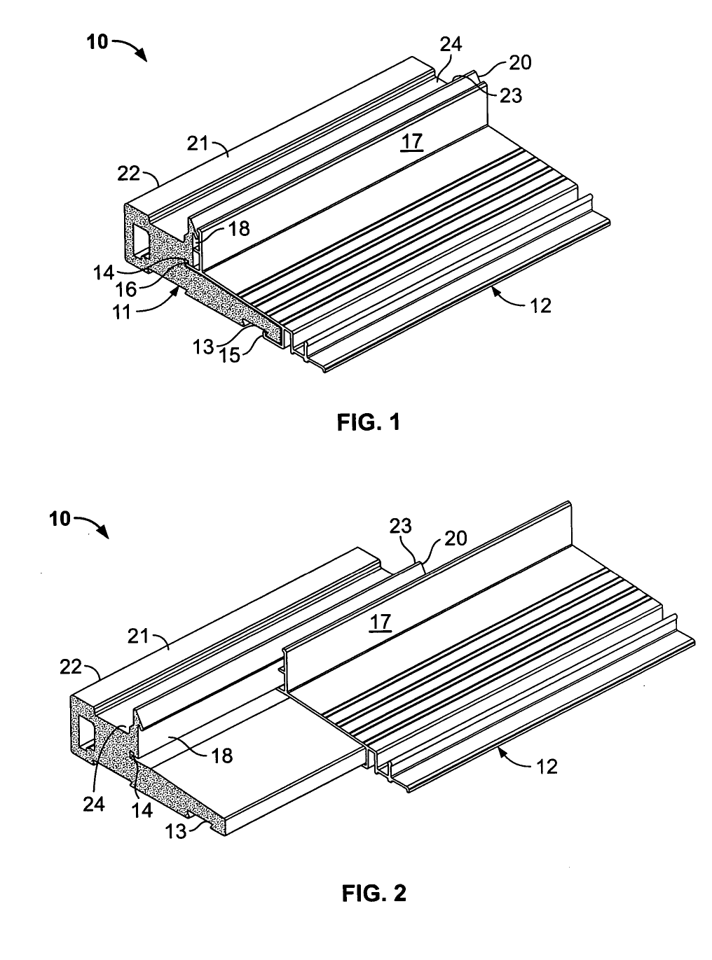

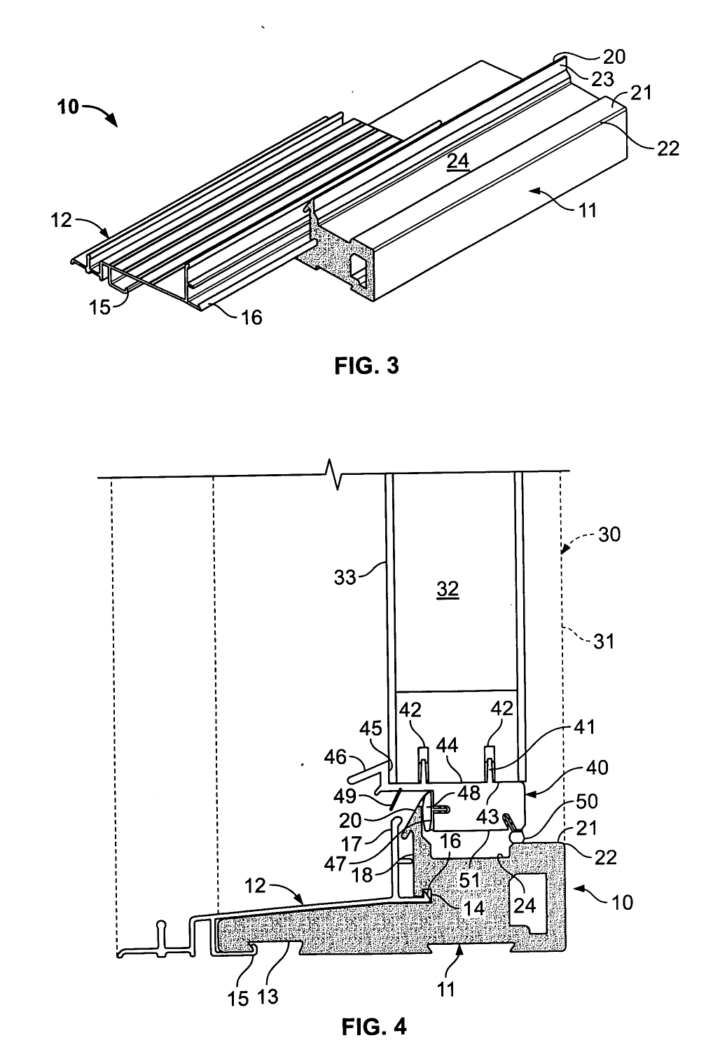

This invention takes advantage of the foregoing features by combining an extruded foamed profile with an extruded aluminum extrusion to create a new sill member 10 for doors, which is shown in FIGS. 1, 2 and 3.

The sill member 10 has two components, an extruded plastic foamed core 11 and an extruded aluminum cap 12. The aluminum cap provides a surface capable of withstanding the heavy pedestrian traffic across a door sill while the core provides a physical base for the cap. In addition the metal cap can add aesthetic features to the component. As shown in the drawings core 11 is formed with grooves 13 and 14 which receive tabs (hooks) 15 and 16 of the cap when these parts are assembled with one another, interlocking them together without other mechanical fastening devices. In FIG. 2 the aluminum cap is shown being partially assembled on the core by sliding it onto the core with the tabs of the cap in the grooves of the core. In general the cap is largely a cover plate over a portion of the core that can have accessory configurations in the extrusion for attaching additional plates and covers. The cap's configuration is not critical and other configurations and interlocking systems can be used as long as a wear plate (cap) is provided over the core structure which receives pedestrian traffic and is subject to outdoor weather conditions. The prior art discloses similar composites of aluminum extrusions and physical cores, see e.g., U.S. Letters Pat. No. 6,125,599 issued to Mees et al showing an aluminum cap/tread assembled on a wooden plank to form a door sill.

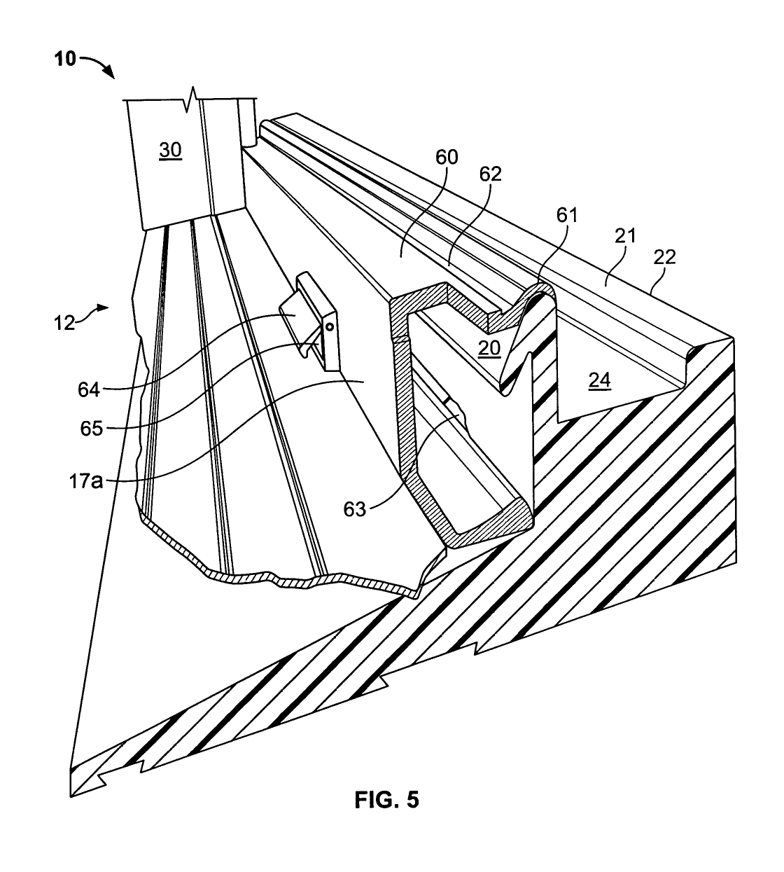

In this invention the core 11 is specially configured as can be seen in the drawings, see specifically the cross section shown in FIG. 4. It includes a raised rib 20 in its central portion that runs the length of the core and the top of which extends above the top 21 of the base 22 of the core. The raised rim includes a vertical surface 23 which forms part of the improved seal achieved with the invention.

Adjacent to the rib is a drain channel 24 that is formed by a depression in the core that also runs lengthwise of the core. As indicated above these features can be formed in the core during extrusion by dies used in the extrusion process.

As can be seen in FIG. 4 the aluminum cap 12 can include a support 17 to provide physical support for the raised rib 20 as well as to further protect the core 11 from inclement weather conditions. If the support is spaced from the raised rib, as shown in FIG. 4, it also provides a drain channel 18 to shuttle water away from the bottom of the door 32. Eliminating rain water in this area lessen the chances it can be driven beneath the door by impinging wind forces.

The door system consists of the door frame 30, a vertical portion illustrated by broken lines 31 for one side thereof which is connected to the sill member 10 and a door 32 which is hingedly mounted in the frame so the door can be swung to open and close the aperture formed by the door frame and sill (the complete door frame is not shown as it is conventional except for the sill member and configurations at the bottom of the door). In FIG. 4 only the bottom part of this system is shown where it can be seen that a plate 40 is attached to the bottom of the door by self locking pins 41 that are received in apertures 42 in the bottom 43 of the door. The plate has a base 44 that covers the bottom of the door and an upstanding flange 45 that abuts on the outer surface 33 of the door. Depending downwardly from this flange is a deflecting flange 46 that directs rain water running down the outer surface of the door away from the bottom of the door. Set back from the deflecting flange is a vertical surface 47 depending downwardly from the plate so that it will overlap the raised rib 20 when the door 32 is closed. Centrally disposed on the vertical surface is a compressible seal 48 which engages the rib 20 to form a compression seal across the bottom of the door as is apparent from the cross section shown in FIG. 4.

As also can be seen in FIG. 4 plate 40 includes a flexible seal 49 that is disposed between its compressible seal 48 and the deflecting flange 46 that extends below the height of the raised rib 20. Due to the flexibility of this seal, it will be deflected by the raised rib when the door 32 is opened and closed. The purpose of the flexible seal is to deflect some of the wind and wind driven rain before it gets to the compressible seal 48, thereby providing a two stage type seal.

As can be further seen in FIG. 4, the drain channel 24 is directly below the plate 40 so that any rain water that penetrates beyond the flexible seal 49 and the compressible seal 48 will collect in this channel and be drained off at the edges of the sill member 10. In extremely high winds this flexible seal will be driven against the rib 20 to effect a positive seal with any water diverted in the channel 18.

As a final seal, a rub seal 50 is attached to the bottom 51 of the plate 40 adjacent to its inboard edge so that it contacts the top 22 of the base 21 of the core 1 1 outboard of the drain channel 24 so that the rain in the channel cannot pass over the sill member.

In essence the invention provides deflection of rain water accumulating on the surface of the door 34, plus a three stage seal against the intrusion of wind and wind driven rain water under the door 32 which is effective in environs experiencing serious inclement weather conditions.

It can be appreciated, if desired, the surface 47 supporting seal 48 can be set back toward the rub seal 50 so that the thickness of the rib 20 can be increased for structural reasons.

An alternate embodiment is illustrated in FIG. 5 wherein the cap 12 is modified to encase the top of rib 20 by a generally horizontal wall 60 that extends from the top of wall 17a toward the rib and has crown 61 that covers the top of the rib. Adjacent to this crown is a grove 62 that drains the rain water deflected downward by seal 49. Typically this groove will have secondary grooves (not shown) normal to it in the horizontal wall so that in water in this channel can drain onto the top surface of the cap 12.

In this embodiment, a large drainage channel 18a is provided between the cap 12 and the core 11 which is ported to the channel 24 via a channel 63 milled through the core that provides communication from channel 24 to the large drainage channel 18a. If desired, the secondary channel 62 can also be ported to this large drain channel.

Adjacent to the base of wall 17a of the cap 12 shown in FIG. 5 is a drain door 64 that is hinged to cover an opening 65 in the base of the wall. Rain water collecting in the large channel 18a can drain on the surface of cap 12 through this door system. The reason to have the drain door is to prevent insect and other vermin from entering the dwelling via large drain channel 18a through the channel 63 to channel 24. Of course the rub seal 50 limits this pathway when the door is closed, see FIG. 4.

The drain door is designed so that its weight will close it and so that the water pressure from the water in the drain channel will open it.

Having described my invention, I claim:

1. A door system for resisting severe inclement weather: conditions comprising:
a rectangular door frame having an aperture;
a door hingedly mounted on said door frame to swing to open such aperture in said frame and to close such aperture in said door frame;
a sill member at the bottom of said door frame, said sill member formed of an elongated extruded core member of foamed material with interlocking surfaces forming the base component of said sill member and an elongated aluminum extrusion cap with mating interlocking surfaces forming an outer exterior surface of said sill member and assembled on said core member through said interlocking surfaces;
an elongated rib centrally located in said sill member and extending vertically from said sill member along its entire length, the height of said rib being sufficient to overlap a vertical face associated with said door adjacent to the bottom thereof; and
a seal between said vertical face associated with said door and said rib whereby the passage of wind driven rain and wind beneath said door when said door is closed against said seal will be restricted.

2. A door system for resisting severe inclement weather conditions comprising:
a rectangular door frame having an aperture;
a door hingedly mounted on said door frame to swing to open such aperture in said frame and to close such aperture in said door frame;
a sill member at the bottom of said door frame, said sill member completing the bottom of said door frame;
an elongated rib centrally located in said sill member and extending vertically from said sill member along its entire length, the height of said rib being sufficient to overlap a vertical face associated with said door adjacent to the bottom thereof; and
a seal between said vertical face associated with said door and said rib whereby the passage of wind driven rain and wind beneath said door when said door is closed against said seal will be restricted.

3. The door system defined in claim 1 wherein in the seal is an elastomer member.

4. The door system defined in 2 wherein in the seal is an elastomer member.

5. The door system defined in claim 2 wherein the vertical surface associated with the door is part of the lower portion of the door.

6. The door system defined in claim 2 wherein the vertical surface associated with the bottom of the door is formed by a separate vertical surface in a plate member attached to the bottom of said door.

7. The door system defined in claim 6 wherein in the plate member has a downwardly directed angular defecting flange on its outer surface which is located at a height above its separate vertical surface, said flange operable to direct rain water flowing down the face of the door away form the bottom of said door.

8. The door system defined in claim 6 wherein in the wherein the plate member includes a flexible downwardly directed seal element in front of its separate vertical surface operable to provide a deflecting element for wind and wind driven rain which is lower than the height of the vertical rib and which will deflect as it passes over said rib so said door may be opened and closed.

7. The door system defined in claim 6 wherein in the plate member has a downwardly directed angular defecting flange on its outer surface which is located at a height above its separate vertical surface, said flange operable to direct rain water flowing down the face of the door away form the bottom of said door.

9. The door system defined in claim 7 wherein in the wherein the plate member includes a flexible downwardly directed seal element in front of its separate vertical surface operable to provide a deflecting element for wind and wind driven rain which is lower than the height of the vertical rib and which will deflect as it passes over said rib so said door may be opened and closed.

10. The door system defined in claim 2 wherein in the sill member includes a drain channel running its entire length adjacent to the raised vertical rib to transport rain water from beneath the bottom of the door.

11. The door system defined in claim 1 wherein in the sill member includes a drain channel running its entire length adjacent to the raised vertical rib to transport rain water from beneath the bottom of the door.

12. The door system defined in claim 11 wherein the plate member includes a separate rubbing seal along it inside bottom edge operable to contact the sill member to form a seal outboard board of the drain channel.

13. The door system defined in claim 11 wherein the cap has a drain door to discharge the rain water collecting the drain channel which opens under the pressure of water collecting in said drain channel.

14. The door system defined in claim 11 wherein a separate drain channel extending the length of the sill on the opposite side of the rib.

15. The door system defined in claim 1 wherein an aluminum extrusion has a crown portion which covers the top of the rib.

16. The door system defined in claim 2 wherein an aluminum extrusion has a crown portion which covers the top of the rib.
